(19) United States
(12) Patent Application Publication
(10) Pub. No.: US 2021/0018088 A1
(43) Pub. Date: Jan. 21, 2021

(54) OIL SUPPLY SYSTEM FOR VEHICLE

(71) Applicants: TOYOTA JIDOSHA KABUSHIKI KAISHA, Toyota-shi (JP); AISIN AW CO., LTD., Anjo-shi (JP)

(72) Inventors: Guodong TAN, Toyota-shi (JP); Shinichi ITO, Anjo-shi (JP); Yukihiko IDESHIO, Nissin-shi (JP); Masashi IKEMURA, Toyota-shi (JP); Ryota YOSHIMOTO, Anjo-shi (JP); Shinichiro MATSUBARA, Anjo-shi (JP); Masamichi YAMAGUCHI, Anjo-shi (JP); Takashi IIJIMA, Anjo-shi (JP)

(73) Assignees: TOYOTA JIDOSHA KABUSHIKI KAISHA, Toyota-shi (JP); AISIN AW CO., LTD., Anjo-shi (JP)

(21) Appl. No.: 16/926,820

(22) Filed: Jul. 13, 2020

(30) Foreign Application Priority Data
Jul. 18, 2019 (JP) 2019-133033

(51) Int. Cl. F16H 57/04; F16N 7/40; F16H 61/00; F15B 15/20

(52) U.S. Cl. CPC F16H 57/0446; F16N 7/40; F16H 61/0025; F16H 2708/20; F16H 57/0484; F16H 2061/0037; F15B 15/20

(57) ABSTRACT

An oil supply system for a vehicle includes a plurality of oil pumps, suction oil passages, and a communication passage. The oil pumps are independently operational. The suction oil passages each connect an associated one of suction portions of the plurality of oil pumps and a common oil strainer. The communication passage connects the suction oil passages.

### CROSS-REFERENCE TO RELATED APPLICATION

This application claims priority to Japanese Patent Application No. 2019-133033 filed on Jul. 18, 2019, incorporated herein by reference in its entirety.

### BACKGROUND

### 1. Technical Field

The disclosure relates to an oil supply system for a vehicle, which includes a plurality of oil pumps to which oil is supplied from a common oil strainer.

### 2. Description of Related Art

An oil supply system for a vehicle, which includes two oil pumps that are supplied with oil from a common oil strainer and that are independently operational, is known. This is, for example, the oil supply system for a vehicle, described in Japanese Unexamined Patent Application Publication No. 2016-017556 (JP 2016-017556 A). In the oil supply system for a vehicle, described in JP 2016-017556 A, oil passages are bifurcated from one oil passage connected to the common oil strainer and respectively connected to suction ports of the oil pumps.

### SUMMARY

An example of the configuration of oil passages in an oil supply system for a vehicle, which includes two oil pumps that are supplied with oil stored in an oil pan from a common strainer and that are independently operational, is conceivable as shown in FIG. 7. In this configuration, a suction oil passage 142 that connects a suction port of an oil pump 140 and a common oil strainer 92 and a suction oil passage 152 that connects a suction port of an oil pump 150 and the common oil strainer 92 are provided independently of each other.

However, with the thus configured oil passages, when the oil pump 140 is driven and the oil pump 150 is stopped, oil is supplied from the oil strainer 92 to the suction port of the oil pump 140 via the suction oil passage 142, while oil 98 in the suction oil passage 152 is drawn back to the oil strainer 92 under the negative suction pressure of the oil pump 140 in operation, as indicated by the dashed arrow in FIG. 7. Suction pressure (negative pressure) is a pressure that works at a suction port of an oil pump when the oil pump is in operation and is a pressure lower than atmospheric pressure. For this reason, when the operation of the oil pump 150 is started, the suction oil passage 152 is filled with the oil 98 and then oil supply from a discharge port of the oil pump 150 is started. Therefore, it is inconvenient that the response of oil supply at the time when the operation of the oil pump 150 is started delays.

In addition, when the oil 98 in the suction oil passage 152 is drawn back to the oil strainer 92, the oil 98 may leave the suction oil passage 152 and air may accumulate. Thus, when the operation of the oil pump 150 is started, the oil pump 150 initially draws air accumulated in the suction oil passage 152. The oil pump 150 designed as an oil pump may have a significantly decreased efficiency when drawing air and impair the function of pump.

For this reason, when an air outlet port 156 is provided in a discharge oil passage 154 on a discharge side of the oil pump 150, air is easily released. However, when the air outlet port 156 is provided, the oil 98 may be drained through the air outlet port 156, which may impair the efficiency of the pump.

The disclosure improves the response of oil supply at the time when the operation of an oil pump not in operation is started.

An aspect of the disclosure provides an oil supply system for a vehicle. The oil supply system includes a plurality of oil pumps, suction oil passages, and a communication passage. The oil pumps are independently operational. The suction oil passages each connect an associated one of suction portions of the plurality of oil pumps and a common oil strainer. The communication passage connects the suction oil passages.

With the above configuration, the suction oil passages each connecting an associated one of the suction portions of the plurality of oil pumps and the common oil strainer are provided independently of each other, and the communication passage connecting the suction oil passages is provided. Thus, when any one of the plurality of oil pumps is in operation, oil is supplied to the suction portion of the oil pump in operation from the oil strainer via the suction oil passage, connecting the suction portion of the oil pump not in operation and the oil strainer, and the communication passage. Therefore, a state where the suction oil passage connecting the suction portion of the oil pump not in operation and the oil strainer is filled with oil is maintained. Hence, as compared to when no communication passage is provided, the response of oil supply at the time when the operation of the oil pump not in operation is started is improved.

The oil supply system may further include a common output oil passage connected to each of discharge portions of the plurality of oil pumps.

With the above configuration, the discharge portions are connected to the common output oil passage. Thus, when the operating status (operating state or non-operating state) of each of the plurality of oil pumps is switched, oil supply from the oil supply system to the common output oil passage can be changed with good response.

In the oil supply system, the plurality of oil pumps each may be configured to supply a hydraulic control circuit with a source pressure for at least one of shift control over a speed ratio in a transmission mechanism and supply of lubricating oil to the transmission mechanism.

With the above configuration, the source pressure for at least one of shift control over the speed ratio in the transmission mechanism and supply of lubricating oil to the transmission mechanism is supplied. Thus, shift control over the speed ratio in the transmission mechanism or control over the amount of lubricating oil supplied is performed with good response.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an example of a configuration diagram of a vehicle according to embodiments of the disclosure;

FIG. 2 is an operation chart that shows combinations of hydraulic frictional engagement devices used to establish shift stages in a step transmission section provided in a powertrain of FIG. 1;

FIG. 3 is a configuration diagram of an oil supply system for a vehicle according to a first embodiment of the disclosure;

FIG. 4 is a configuration diagram of an oil supply system for a vehicle according to a second embodiment of the disclosure;

FIG. 5 is a configuration diagram of an oil supply system for a vehicle according to another embodiment of the disclosure;

FIG. 6 is a configuration diagram of an oil supply system for a vehicle according to another embodiment of the disclosure; and

FIG. 7 is a configuration diagram of an oil supply system for a vehicle according to a comparative example.

### DETAILED DESCRIPTION OF EMBODIMENTS

Hereinafter, embodiments of the disclosure will be described in detail with reference to the accompanying drawings. In the following embodiments, drawings are simplified or deformed where appropriate, and the scale ratio, shape, and the like, of each component are not always drawn accurately.

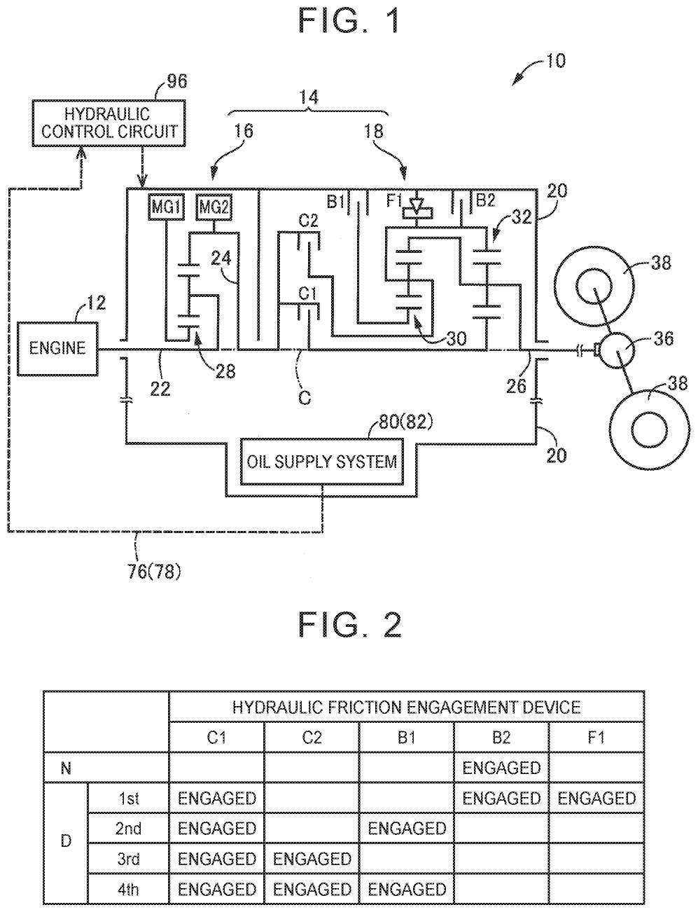

FIG. 1 is an example of the configuration diagram of a vehicle 10 according to the embodiments of the disclosure. The vehicle 10 is, for example, a hybrid vehicle. The vehicle 10 includes an engine 12, a first electric motor MG1, a second electric motor MG2, a powertrain 14, a differential gear unit 36, a pair of drive wheels 38, an oil supply system 80 for a vehicle, and a hydraulic control circuit 96. Reference numerals in parentheses in FIG. 1 are used for a second embodiment (described later).

The engine 12 is an internal combustion engine, such as a gasoline engine and a diesel engine.

The powertrain 14 is shown by skeletal view in FIG. 1. The powertrain 14 is configured substantially symmetrically with respect to a rotation center line C. In the skeletal view of FIG. 1, the lower half of the powertrain 14 below the rotation center line C is omitted. The powertrain 14 accommodated in a housing 20 includes an input shaft 22, a differential section 16, a step transmission section 18, and an output shaft 26 between the engine 12 and the drive wheels 38.

The input shaft 22 is an input rotating member in the powertrain 14 and is disposed along the common rotation center line C in the housing 20. The housing 20 serves as a non-rotating member secured to a vehicle body. The differential section 16 is a continuously variable transmission section coupled directly to the input shaft 22 or indirectly to the input shaft 22 via a pulsation absorbing damper (not shown), or the like. The step transmission section 18 is coupled to the differential section 16 via a transmission member 24. The output shaft 26 is an output rotating member in the powertrain 14 and is coupled to the step transmission section 18.

The differential section 16 mechanically distributes power input from the input shaft 22 between the first electric motor MG1 and the second electric motor MG2. The second electric motor MG2 is operationally coupled to the transmission member 24 so as to integrally rotate with the transmission member 24. The first electric motor MG1 and the second electric motor MG2 each are connected to an electrical storage device via an associated inverter (not shown). Rotation control of each of the first electric motor MG1 and the second electric motor MG2 is executed by the associated inverter being controlled. Each of the first electric motor MG1 and the second electric motor MG2 is a so-called motor generator that functions as both a motor and a generator. The differential section 16 is mainly made up of a single pinion planetary gear train 28 for distributing power. The first electric motor MG1, the second electric motor MG2. and the planetary gear train 28 are coupled as shown in FIG. 1.

The step transmission section 18 is provided between the transmission member 24 and the output shaft 26. The step transmission section 18 is a planetary gear-type multi-stage transmission that includes a single pinion first planetary gear train 30, a single pinion second planetary gear train 32, a first clutch C1, a second clutch C2, a first brake B1, a second brake B2, and a one-way clutch F1 and that functions as a step automatic transmission. The first planetary gear train 30, the second planetary gear train 32, the first clutch C1, the second clutch C2, the first brake B1, the second brake B2, and the one-way clutch F1 are coupled as shown in FIG. 1. Each of the first clutch C1 and the second clutch C2 is a hydraulic frictional engagement device that is selectively engaged or released. Each of the first brake B1 and the second brake B2 is a hydraulic frictional engagement device that is selectively engaged with or released from the housing 20 that is the non-rotating member. The step transmission section 18 changes the speed of rotation of the transmission member 24 and outputs the rotation to the output shaft 26. The differential section 16 and the step transmission section 18 are an example of the “transmission mechanism” in the aspect of the disclosure.

Power transmitted to the output shaft 26 of the powertrain 14 is transmitted to the drive wheels 38 via the differential gear unit 36.

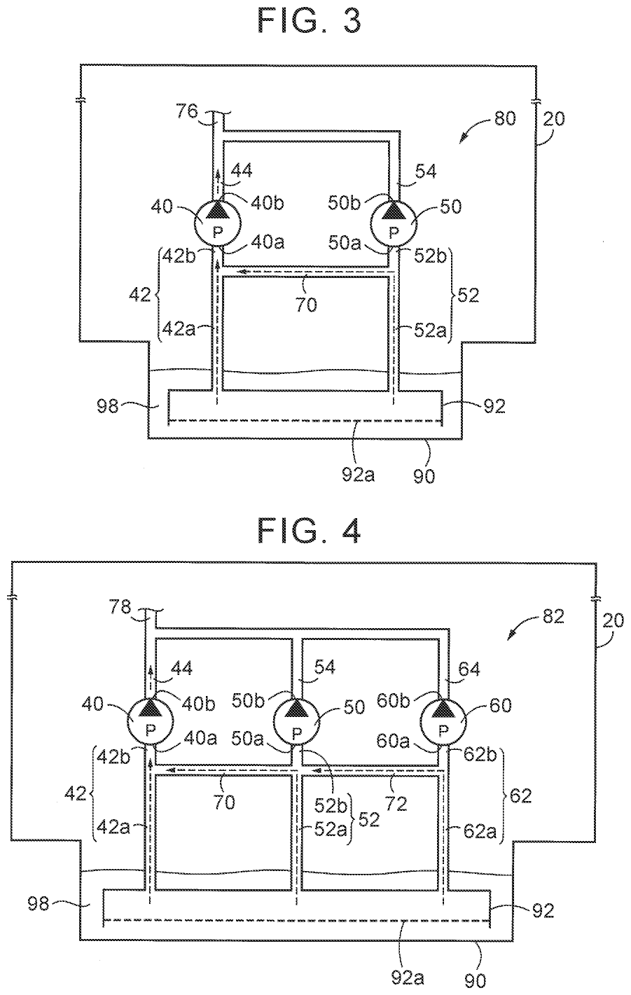

The oil supply system 80 pumps oil 98 (see FIG. 3) to the hydraulic control circuit 96. The hydraulic pressure of the oil 98 pumped to the hydraulic control circuit 96 becomes a source pressure for shift control over shift stages in the step transmission section 18 and supplying lubricating oil to the powertrain 14 in the hydraulic control circuit 96.

Hydraulic control signals for controlling a shift of the step transmission section 18 are input from an electronic control unit (ECU) (not shown) to the hydraulic control circuit 96. The hydraulic control circuit 96 generates controlled hydraulic pressures for engaging or releasing the hydraulic frictional engagement devices (the first clutch C1, the second clutch C2, the first brake B1, and the second brake B2) provided in the step transmission section 18 based on the input hydraulic control signals by using the hydraulic pressure of the pumped oil 98 as a source pressure, and outputs the controlled hydraulic pressures to actuators of the hydraulic frictional engagement devices, respectively. The hydraulic control circuit 96 also generates a lubricating oil pressure regulated for supplying lubricating oil by using the hydraulic pressure of the pumped oil 98 as a source pressure and supplies the oil 98 as lubricating oil to the powertrain 14 including the step transmission section 18.

FIG. 2 is an operation chart that shows combinations of the hydraulic frictional engagement devices used to establish shift stages in the step transmission section 18 provided in the powertrain 14 of FIG. 1. Among the hydraulic frictional engagement devices of FIG. 2, “ENGAGED” indicates an engaged state, and blank indicates a released state.

In FIG. 2, “N” and “D” respectively represent a neutral range and a drive range that are alternatively selected by manual operation of a shift lever (not shown). The neutral range is a non-driving range that is selected when the vehicle 10 is not caused to travel. The drive range is a driving range that is selected when the vehicle 10 is caused to travel forward. The range of the powertrain 14 is changed according to a combination of engaged and released states of the hydraulic frictional engagement devices shown in FIG. 2.

FIG. 3 is a configuration diagram of the oil supply system 80 according to the first embodiment of the disclosure.

Oil 98 (for example, automatic transmission fluid (ATF)) stored in an oil pan 90 is supplied from an oil strainer 92 to the oil supply system 80. The oil pan 90 is provided at the bottom of the housing 20 that accommodates the powertrain 14. The oil strainer 92 has a wire gauze 92a and filters relatively large foreign matter from the oil 98. The filtered oil 98 is supplied to the oil supply system 80.

The oil supply system 80 includes a mechanical oil pump 40, an electric oil pump 50, a first suction oil passage 42, a second suction oil passage 52, and a first bypass oil passage 70. The first suction oil passage 42 connects a suction port 40a of the mechanical oil pump 40 and the oil strainer 92. The second suction oil passage 52 connects a suction port 50a of the electric oil pump 50 and the oil strainer 92. The first bypass oil passage 70 connects the first suction oil passage 42 and the second suction oil passage 52.

The mechanical oil pump 40 is, for example, a known internal gear or external gear mechanical oil pump that is rotationally driven by the input shaft 22 coupled to the engine 12. The electric oil pump 50 is, for example, a known internal gear or external gear electric oil pump that is rotationally driven by an electric motor (motor) (not shown). The mechanical oil pump 40 is rotationally driven by the engine 12. The electric oil pump 50 is rotationally driven by the electric motor (motor). Therefore, each of the mechanical oil pump 40 and the electric oil pump 50 is driven by an independent drive source. The operating status, that is, operating state or non-operating state, of one of the mechanical oil pump 40 and the electric oil pump 50 is controllable regardless of the operating status of the other oil pump. In other words, the mechanical oil pump 40 and the electric oil pump 50 are operational independently. The mechanical oil pump 40 and the electric oil pump 50 in the present embodiment each are an example of the “oil pump” in the aspect of the disclosure.

The first suction oil passage 42 including an oil passage 42a and an oil passage 42b connects the suction port 40a of the mechanical oil pump 40 and the oil strainer 92. The first suction oil passage 42 functions as an oil passage that supplies the oil 98 to the mechanical oil pump 40, that is, a suction oil passage for the mechanical oil pump 40. The oil passage 42a is an oil passage closer to the oil strainer 92 in the first suction oil passage 42. The oil passage 42b is an oil passage closer to the suction port 40a in the first suction oil passage 42. One side of the oil passage 42a is connected to the oil strainer 92, and the other side of the oil passage 42a is connected to the oil passage 42b. One side of the oil passage 42b is connected to the oil passage 42a, and the other side of the oil passage 42b is connected to the suction port 40a. A discharge port 40b of the mechanical oil pump 40 is connected to a first discharge oil passage 44. The suction port 40a is an opening part through which the oil 98 is drawn into the mechanical oil pump 40. The discharge port 40b is an opening part through which the oil 98 is discharged from the mechanical oil pump 40.

The second suction oil passage 52 including an oil passage 52a and an oil passage 52b connects the suction port 50a of the electric oil pump 50 and the oil strainer 92. The second suction oil passage 52 functions as an oil passage that supplies the oil 98 to the electric oil pump 50, that is, a suction oil passage for the electric oil pump 50. The oil passage 52a is an oil passage closer to the oil strainer 92 in the second suction oil passage 52. The oil passage 52b is an oil passage closer to the suction port 50a in the second suction oil passage 52. One side of the oil passage 52a is connected to the oil strainer 92, and the other side of the oil passage 52a is connected to the oil passage 52b. One side of the oil passage 52b is connected to the oil passage 52a, and the other side of the oil passage 52b is connected to the suction port 50a. A discharge port 50b of the electric oil pump 50 is connected to a second discharge oil passage 54. The suction port 50a is an opening part through which the oil 98 is drawn into the electric oil pump 50. The discharge port 50b is an opening part through which the oil 98 is discharged from the electric oil pump 50. The suction port 40a and the suction port 50a each are an example of the “suction portion” in the aspect of the disclosure. The discharge port 40b and the discharge port 50b each are an example of the “discharge portion” in the aspect of the disclosure.

The first suction oil passage 42 and the second suction oil passage 52 are connected to the common oil strainer 92. The first suction oil passage 42 is a route through which the oil 98 flows from the oil strainer 92 to the suction port 40a of the mechanical oil pump 40. The second suction oil passage 52 is a route through which the oil 98 flows from the oil strainer 92 to the suction port 50a of the electric oil pump 50. The first suction oil passage 42 and the second suction oil passage 52 have no common part in the routes. In other words, the first suction oil passage 42 and the second suction oil passage 52 are independent of each other. The first suction oil passage 42 and the second suction oil passage 52 are an example of the “suction oil passages each connecting an associated one of suction portions of the plurality of oil pumps and the common oil strainer” in the aspect of the disclosure.

The first bypass oil passage 70 connecting the first suction oil passage 42 and the second suction oil passage 52 is provided between a connection point of the oil passage 42a and the oil passage 42b and a connection point of the oil passage 52a and the oil passage 52b. Therefore, in the oil supply system 80 in which the suction oil passage (the first suction oil passage 42) that connects the suction port 40a of the mechanical oil pump 40 and the oil strainer 92 and the suction oil passage (the second suction oil passage 52) that connects the suction port 50a of the electric oil pump 50 and the oil strainer 92 are provided, the first bypass oil passage 70 connects the suction oil passages. The first bypass oil passage 70 is an example of the “communication passage” in the aspect of the disclosure.

The discharge port 40b of the mechanical oil pump 40 and the discharge port 50b of the electric oil pump 50 are connected to a common output oil passage 76 via the first discharge oil passage 44 and the second discharge oil passage 54.

When the mechanical oil pump 40 is in operation and the electric oil pump 50 is not in operation, oil is supplied from the oil strainer 92 to the suction port 40a via a first route running through the oil passage 42a and the oil passage 42b and a second route running through the oil passage 52a, the first bypass oil passage 70, and the oil passage 42b, as indicated by the dashed line arrows in FIG. 3. In this case, because of oil supply through the second route, a state where the oil passage 52a in the second suction oil passage 52 is filled with the oil 98 is maintained. When the operation of the electric oil pump 50 is started in addition to the operation of the mechanical oil pump 40 from this state, since the oil passage 52a is already filled with the oil 98, oil supply from the discharge port 50b of the electric oil pump 50 is started once the oil passage 52b is filled with the oil 98. Filling only the oil passage 52b that is part of the second suction oil passage 52 can take shorter time than filling the entire second suction oil passage 52 with the oil 98, so the response of oil supply at the time when the operation of the electric oil pump 50 is started improves.

When the electric oil pump 50 is in operation and the mechanical oil pump 40 is not in operation, oil is supplied from the oil strainer 92 to the suction port 50a via a third route running through the oil passage 52a and the oil passage 52b and a fourth route running through the oil passage 42a, the first bypass oil passage 70, and the oil passage 52b. In this case, because of oil supply through the fourth route, a state where the oil passage 42a in the first suction oil passage 42 is filled with the oil 98 is maintained. When the operation of the mechanical oil pump 40 is started in addition to the operation of the electric oil pump 50 from this state, since the oil passage 42a is already filled with the oil 98, oil supply from the discharge port 40b of the mechanical oil pump 40 is started once the oil passage 42b is filled with the oil 98. Filling only the oil passage 42b that is part of the first suction oil passage 42 can take shorter time than filling the entire first suction oil passage 42 with the oil 98, so the response of oil supply at the time when the operation of the mechanical oil pump 40 is started improves.

According to the present embodiment, the first suction oil passage 42 that connects the suction port 40a of the mechanical oil pump 40 and the common oil strainer 92 and the second suction oil passage 52 that connects the suction port 50a of the electric oil pump 50 and the common oil strainer 92 are independent of each other, and the first bypass oil passage 70 connects the first suction oil passage 42 and the second suction oil passage 52. Thus, when one of the mechanical oil pump 40 and the electric oil pump 50 is in operation, the oil 98 is supplied from the oil strainer 92 to the suction port of the oil pump not in operation via part of the suction oil passage of the other oil pump not in operation and the first bypass oil passage 70. Therefore, a state where the part of the suction oil passage of the oil pump not in operation is filled with the oil 98 is maintained. Hence, as compared to when no first bypass oil passage 70 is provided, the response of oil supply at the time when the operation of the oil pump not in operation is started is improved.

According to the present embodiment, the discharge port 40b of the mechanical oil pump 40 and the discharge port 50b of the electric oil pump 50 are connected to the common output oil passage 76. In other words, each of the discharge ports of the mechanical oil pump 40 and electric oil pump 50 is connected to the common output oil passage 76. Thus, when the operating status (operating state or non-operating state) of each of the mechanical oil pump 40 and the electric oil pump 50 is switched, oil supply from the oil supply system 80 to the common output oil passage 76 can be changed with good response.

According to the present embodiment, the source pressure for shift control over shift stages in the step transmission section 18 and supply of lubricating oil to the powertrain 14 is supplied to the hydraulic control circuit 96. Thus, shift control over shift stages in the step transmission section 18 and control over the amount of lubricating oil supplied to the powertrain 14 can be performed with good response.

FIG. 4 is a configuration diagram of an oil supply system 82 for a vehicle according to a second embodiment of the disclosure. The present embodiment has substantially the same configuration as that of the above-described first embodiment and differs from the first embodiment in that the vehicle 10 includes the oil supply system 82 instead of the oil supply system 80. The oil supply system 82 according to the second embodiment has substantially the same configuration as that of the oil supply system 80 according to the above-described first embodiment and differs from that of the first embodiment in that an electric oil pump 60 is provided in addition to the mechanical oil pump 40 and the electric oil pump 50. Therefore, the different portion will be mainly described, like reference numerals denote substantially the same portions in function to those of the above-described first embodiment, and the description thereof is omitted as needed.

The oil supply system 82 includes the mechanical oil pump 40, the electric oil pump 50, the electric oil pump 60, the first suction oil passage 42, the second suction oil passage 52, a third suction oil passage 62, the first bypass oil passage 70, and a second bypass oil passage 72. The third suction oil passage 62 connects a suction port 60a of the electric oil pump 60 and the oil strainer 92. The second bypass oil passage 72 connects the second suction oil passage 52 and the third suction oil passage 62.

The electric oil pump 60 is, for example, a known internal gear or external gear electric oil pump that is rotationally driven by an electric motor (motor) (not shown). The electric motor that rotationally drives the electric oil pump 50 and the electric motor that rotationally drives the electric oil pump 60 are different electric motors. Therefore, each of the mechanical oil pump 40, the electric oil pump 50, and the electric oil pump 60 is driven by an independent drive source. The operating status, that is, operating state or non-operating state, of one of the mechanical oil pump 40, the electric oil pump 50, and the electric oil pump 60 is controllable regardless of the operating status of the other oil pumps. In other words, the mechanical oil pump 40, the electric oil pump 50, and the electric oil pump 60 are independently operational. The mechanical oil pump 40, the electric oil pump 50, and the electric oil pump 60 in the present embodiment each are an example of the “oil pump” in the aspect of the disclosure.

The third suction oil passage 62 including an oil passage 62a and an oil passage 62b connects the suction port 60a of the electric oil pump 60 and the oil strainer 92. The third suction oil passage 62 functions as an oil passage that supplies the oil 98 to the electric oil pump 60, that is, a suction oil passage for the electric oil pump 60. The oil passage 62a is an oil passage closer to the oil strainer 92 in the third suction oil passage 62. The oil passage 62b is an oil passage closer to the suction port 60a in the third suction oil passage 62. One side of the oil passage 62a is connected to the oil strainer 92, and the other side of the oil passage 62a is connected to the oil passage 62b. One side of the oil passage 62b is connected to the oil passage 62a, and the other side of the oil passage 62b is connected to the suction port 60a. A discharge port 60b of the electric oil pump 60 is connected to a third discharge oil passage 64. The suction port 60a is an opening part through which the oil 98 is drawn into the electric oil pump 60. The discharge port 60b is an opening part through which the oil 98 is discharged from the electric oil pump 60. The suction port 40a, the suction port 50a, and the suction port 60a each are an example of the “suction portion” in the aspect of the disclosure. The discharge port 40b, the discharge port 50b, and the discharge port 60b each are an example of the “discharge portion” in the aspect of the disclosure.

The first suction oil passage 42, the second suction oil passage 52, and the third suction oil passage 62 are connected to the common oil strainer 92. The first suction oil passage 42 is a route through which the oil 98 flows from the oil strainer 92 to the suction port 40a of the mechanical oil pump 40. The second suction oil passage 52 is a route through which the oil 98 flows from the oil strainer 92 to the suction port 50a of the electric oil pump 50. The third suction oil passage 62 is a route through which the oil 98 flows from the oil strainer 92 to the suction port 60a of the electric oil pump 60. The first suction oil passage 42, the second suction oil passage 52, and the third suction oil passage 62 have no common part in the routes. In other words, the first suction oil passage 42, the second suction oil passage 52, and the third suction oil passage 62 are independent of one another. The first suction oil passage 42, the second suction oil passage 52, and the third suction oil passage 62 are an example of the “suction oil passages each connecting an associated one of suction portions of the plurality of oil pumps and the common oil strainer” in the aspect of the disclosure.

The second bypass oil passage 72 connecting the second suction oil passage 52 and the third suction oil passage 62 is provided between a connection point of the oil passage 52a and the oil passage 52b and a connection point of the oil passage 62a and the oil passage 62b. Therefore, in the oil supply system 82 in which the suction oil passage (the first suction oil passage 42) that connects the suction port 40a of the mechanical oil pump 40 and the oil strainer 92, the suction oil passage (the second suction oil passage 52) that connects the suction port 50a of the electric oil pump 50 and the oil strainer 92, and the suction oil passage (the third suction oil passage 62) that connects the suction port 60a of the electric oil pump 60 and the oil strainer 92 are provided, the first bypass oil passage 70 and the second bypass oil passage 72 connect the suction oil passages. The first bypass oil passage 70 and the second bypass oil passage 72 each are an example of the “communication passage” in the aspect of the disclosure.

The discharge port 40b of the mechanical oil pump 40, the discharge port 50b of the electric oil pump 50, and the discharge port 60b of the electric oil pump 60 are connected to a common output oil passage 78 via the first discharge oil passage 44, the second discharge oil passage 54, and the third discharge oil passage 64.

When the mechanical oil pump 40 is in operation and the electric oil pump 50 and the electric oil pump 60 are not in operation, oil is supplied from the oil strainer 92 to the suction port 40a via a fifth route running through the oil passage 42a and the oil passage 42b, a sixth route running through the oil passage 52a, the first bypass oil passage 70, and the oil passage 42b, and a seventh route running through the oil passage 62a, the second bypass oil passage 72, the first bypass oil passage 70, and the oil passage 42b, as indicated by the dashed line arrows in FIG. 4. In this case, because of oil supply through the sixth route, a state where the oil passage 52a in the second suction oil passage 52 is filled with the oil 98 is maintained. In addition, because of oil supply through the seventh route, a state where the oil passage 62a in the third suction oil passage 62 is filled with the oil 98 is maintained.

When the operation of the electric oil pump 50 is started in addition to the operation of the mechanical oil pump 40 from the state where the mechanical oil pump 40 is in operation and the electric oil pump 50 and the electric oil pump 60 are not in operation, since the oil passage 52a is already filled with the oil 98, oil supply from the discharge port 50b of the electric oil pump 50 is started once the oil passage 52b is filled with the oil 98. Therefore, filling only the oil passage 52b that is part of the second suction oil passage 52 can take shorter time than filling the entire second suction oil passage 52 with the oil 98, so the response of oil supply at the time when the operation of the electric oil pump 50 is started improves.

When the operation of the electric oil pump 60 is started in addition to the operation of the mechanical oil pump 40 from the state where the mechanical oil pump 40 is in operation and the electric oil pump 50 and the electric oil pump 60 are not in operation, since the oil passage 62a is already filled with the oil 98, oil supply from the discharge port 60b of the electric oil pump 60 is started once the oil passage 62b is filled with the oil 98. Therefore, filling only the oil passage 62b that is part of the third suction oil passage 62 can take shorter time than filling the entire third suction oil passage 62 with the oil 98, so the response of oil supply at the time when the operation of the electric oil pump 60 is started improves.

Similarly, when part of the mechanical oil pump 40, the electric oil pump 50, and the electric oil pump 60 is/are in operation and the remaining oil pump(s) is/are not in operation, a state where part of the suction oil passage(s) of the oil pump(s) not in operation is/are filled with the oil 98 is maintained, so the response of oil supply at the time when the operation of the oil pump(s) not in operation is started improves.

According to the present embodiment, the first suction oil passage 42 that connects the suction port 40a of the mechanical oil pump 40 and the common oil strainer 92, the second suction oil passage 52 that connects the suction port 50a of the electric oil pump 50 and the common oil strainer 92, and the third suction oil passage 62 that connects the suction port 60a of the electric oil pump 60 and the common oil strainer 92 are independent of one another, the first bypass oil passage 70 connects the first suction oil passage 42 and the second suction oil passage 52, and the second bypass oil passage 72 connects the second suction oil passage 52 and the third suction oil passage 62. Thus, when one or some of the mechanical oil pump 40, the electric oil pump 50, and the electric oil pump 60 are in operation, the oil 98 is supplied from the oil strainer 92 to the suction port(s) of the oil pump(s) in operation via part of the suction oil passage(s) of the oil pump(s) not in operation, the first bypass oil passage 70, and the second bypass oil passage 72. Therefore, a state where the part of the suction oil passage(s) of the oil pump(s) not in operation is/are filled with the oil 98 is maintained. Hence, as compared to when neither the first bypass oil passage 70 nor the second bypass oil passage 72 is provided, the response of oil supply at the time when the operation of the oil pump(s) not in operation is started is improved.

According to the present embodiment, as in the case of the above-described first embodiment, when the operating status (operating state or non-operating state) of each of the mechanical oil pump 40, the electric oil pump 50, and the electric oil pump 60 is switched, oil supply from the oil supply system 82 to the common output oil passage 78 can be changed with good response. In addition, shift control over shift stages in the step transmission section 18 and control over the amount of lubricating oil supplied to the powertrain 14 can be performed with good response.

The embodiments of the disclosure are described with reference the drawings; however, the disclosure is also applicable to other embodiments.

In the above-described first embodiment, the oil supply system 80 includes the mechanical oil pump 40 and the electric oil pump 50, and, in the second embodiment, the oil supply system 82 includes the mechanical oil pump 40 and the electric oil pumps 50, 60; however, the configuration is not limited thereto. For example, an oil supply system for a vehicle may include a plurality of electric oil pumps that are independently operational without including a mechanical oil pump.

In the above-described first embodiment, the oil supply system 80 includes two oil pumps, that is, the mechanical oil pump 40 and the electric oil pump 50, and, in the second embodiment, the oil supply system 82 includes three oil pumps, that is, the mechanical oil pump 40 and the electric oil pumps 50, 60; however, the number of oil pumps is not limited to two or three. The oil supply system for a vehicle just needs to include a plurality of oil pumps that are independently operational.

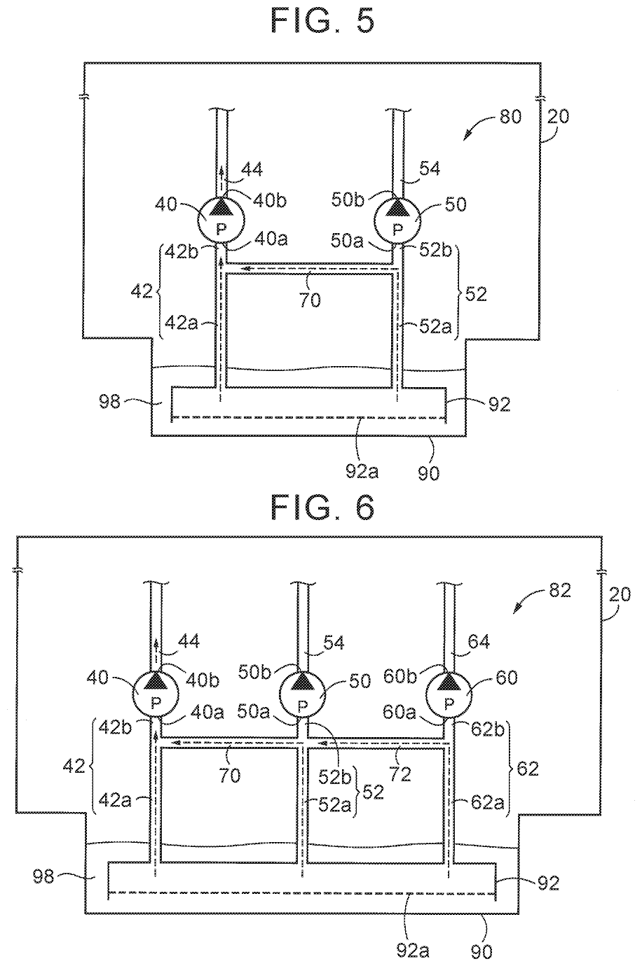

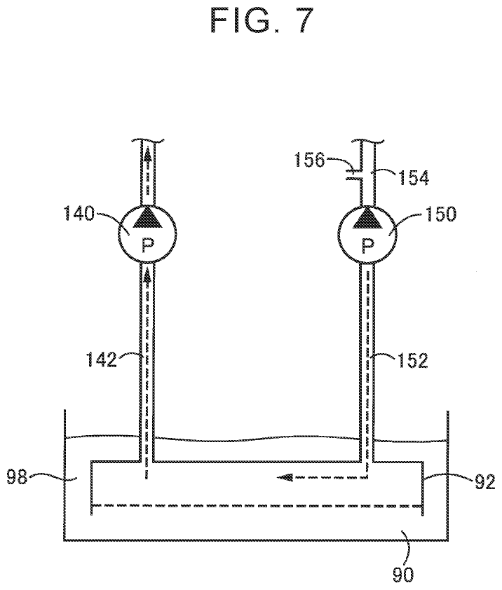

In the above-described first embodiment, the discharge port 40b of the mechanical oil pump 40 and the discharge port 50b of the electric oil pump 50 are connected to the common output oil passage 76, and, in the above-described second embodiment, the discharge port 40b of the mechanical oil pump 40, the discharge port 50b of the electric oil pump 50, and the discharge port 60b of the electric oil pump 60 are connected to the common output oil passage 78; however, the configuration is not limited thereto. For example, the discharge ports of the plurality of oil pumps may be not connected to the common output oil passage, and the oil 98 may be supplied to different destinations to be supplied. For example, this is the configuration shown in FIG. 5 or FIG. 6. With such a configuration as well, when part of the oil pumps is/are in operation and the remaining oil pump(s) is/are not in operation, a state where part of the suction oil passage(s) of the oil pump(s) not in operation is/are filled with the oil 98 is maintained, so the response of oil supply at the time when the operation of the oil pump(s) not in operation is started improves.

In the above-described second embodiment, the oil supply system 82 includes the oil passage 42b, the oil passage 52b, and the oil passage 62b; however, the oil supply system 82 does not have to include the oil passage 42, the oil passage 52b, and the oil passage 62b. For example, the oil supply system 82 may be configured such that the suction port 40a is connected to the first suction oil passage 42 and the first bypass oil passage 70, the suction port 50a is connected to the second suction oil passage 52, the first bypass oil passage 70, and the second bypass oil passage 72, and the suction port 60a is connected to the third suction oil passage 62 and the second bypass oil passage 72. In such a configuration, when part of the mechanical oil pump 40, the electric oil pump 50, and the electric oil pump 60 is/are in operation and the remaining one or two are not in operation, a state where the entire suction oil passage(s) of the oil pump(s) not in operation is/are filled with the oil 98 is maintained. Therefore, when the operation of the oil pump(s) not in operation is started from this state, oil supply is quickly started from the discharge port(s) of the oil pump(s). In this way, as compared to the configuration including the oil passage 42b, the oil passage 52b, and the oil passage 62b, the response of oil supply at the time when the operation of the oil pump(s) not in operation is started further improves. Similarly, in the above-described first embodiment, a configuration that does not include both the oil passage 42b and the oil passage 52b may be employed.

In the above-described first and second embodiments, the transmission mechanism of the vehicle 10 is the differential section 16 that is the continuously variable transmission section or the step transmission section 18 that is a planetary gear-type multi-stage transmission; however, the transmission mechanism is not limited thereto. For example, the transmission mechanism of the vehicle 10 may be a transmission mechanism of another type, such as a constant-mesh parallel shaft-type step transmission or belt-type continuously variable transmission, and the oil supply system 80 or the oil supply system 82 may be configured to supply the hydraulic control circuit 96 with a source pressure for shift control over speed ratios in the transmission mechanism of another type.

In the above-described first and second embodiments, the hydraulic control circuit 96 performs both shift control over shift stages in the step transmission section 18 and supply of lubricating oil to the powertrain 14 including the step transmission section 18. Alternatively, the hydraulic control circuit 96 may be configured to perform at least one of them.

In the above-described first and second embodiments, the vehicle 10 is a hybrid vehicle; however, the vehicle 10 is not limited thereto. For example, the vehicle 10 may include only the engine 12 as a drive source of the vehicle 10 without including the first electric motor MG1 or the second electric motor MG2.

The above-described embodiments are only illustrative. The disclosure may be implemented in modes including various modifications or improvements based on the knowledge of persons skilled in the art.

What is claimed is:

1. An oil supply system for a vehicle, the oil supply system comprising:
a plurality of oil pumps that are independently operational;
suction oil passages each connecting an associated one of suction portions of the plurality of oil pumps and a common oil strainer; and
a communication passage connecting the suction oil passages.

2. The oil supply system according to claim 1, further comprising a common output oil passage connected to each of discharge portions of the plurality of oil pumps.

3. The oil supply system according to claim 1, wherein the plurality of oil pumps each are configured to supply a hydraulic control circuit with a source pressure for at least one of shift control over a speed ratio in a transmission mechanism and supply of lubricating oil to the transmission mechanism.
